(19) United States
(12) Patent Application Publication
(10) Pub. No.: US 2002/0095528 A1
(43) Pub. Date: Jul. 18, 2002

(54) Method and system for operating a client in a client/server system

(75) Inventors: Darrin Philip Harper, Clarkville (NZ); Guy Nigel Kendall, Christchurch (NZ); Joseph Mahoney, Wellington (NZ)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 09/969,052

(22) Filed: Sep. 28, 2001

(30) Foreign Application Priority Data
Sep. 29, 2000 (NZ) 507240

(51) Int. Cl. G06F 9/46

(52) U.S. Cl. 709/330

(57) ABSTRACT

This invention relates to a method and system for operating a client in a client/server system. A plurality of requests for action to one or more servers in the system are made and a corresponding plurality of responses to the requests are received from the system. Data relating to the requests and responses are recorded at the client and then the client disconnected from communication with the system. One or more further requests for action are made and responses to the further requests are determined based on the recorded data.

### FIELD OF THE INVENTION

This invention relates to interactions between computer applications in a client/server system, and more particularly to requests made by a client to a server and corresponding responses made to the client by the server. Each interaction is generally but not necessarily in the form of a remote procedure call (RPC) or similar request and response event.

### BACKGROUND OF THE INVENTION

Client/server systems generally involve one or more client terminals such as desktop or laptop computers which are connected through a local or wide area network to one or more server systems and other peripheral devices. The server systems may carry out a wide range of functions and include a wide variety of computer types from relatively small processor boxes to mainframes. Most systems involve some sharing of processes between the clients and servers, and depending on the share of process workload may be described as thin client or fat client systems, for example. The server functions may include activities such as database access, Internet services and more general storage and processing of applications.

Computer programs on clients and servers may communicate in various ways which avoid the need for system developers of client systems to provide or understand specific procedures for the server. A program on the client system may send a message to a server with appropriate arguments or input values. A program on the server will act on the client message and send a message in turn containing results of the action, such as an item of data from a database, for example. The messages are commonly called remote procedure calls or RPCs. Sun Microsystems developed the first widely used RPC protocol as part of the Open Network Computing architecture in the early 1980s. The specification has since been handed off to the Internet Engineering Task Force as a step towards making ONC RPC an Internet standard. Two newer object oriented methods which involve communication over networks are CORBA and DCOM which provide similar capabilities to traditional RPCs. Other specifications such as XML and derivatives such as SOAP are also able to provide these capabilities in an Internet environment.

Client terminals such as laptop computers are often removed from a network or are otherwise unable to communicate with the servers. A user may be travelling and out of contact with their usual computer network for a period of time during which normal RPC events cannot occur. A marketing agent may be visiting customers without ready access to the office network over the PSTN, for example. The agent may wish to demonstrate a software product that would normally require access to server resources on the network via RPCs. One existing method which has been developed to allow the agent to at least partially demonstrate a product under these circumstances involves a screen show in which a sequence of screen states is recorded while the client is in contact with the network, and replayed at the remote location. The method is relatively inflexible and therefore unsatisfactory because of the limited number of variations which an agent can make once the sequence has been recorded.

### SUMMARY OF THE INVENTION

It is an object of the invention to provide for improved operation of client computers when remote from a network and their usual server resources, or at least to provide a useful alternative to existing systems of this general kind.

According to one aspect of the invention, recording requests are made by a particular client along with corresponding responses from the network, so that the client can generate the responses later when remote from the network.

In another aspect of the invention, the present invention is a method of operating a client in a client/server system, comprising: issuing a plurality of requests for action to one or more servers in the system, receiving a plurality of corresponding responses to the requests from the system, recording data at the client relating to the requests and the responses, disconnecting the client from communication with the system, issuing one or more further requests for action, and determining responses to the further requests according to the recorded data.

In another aspect the invention, the present invention is a client computer system including: a connector subsystem which enables connection of the client computer system to a server computer system, at least one client application which can be operated by a user of the client computer system, and a switch subsystem for tracking requests made by the client application to the server system, wherein the switch records request and response interactions between the application and the server system while the client system is connected to the server system, and the switch uses the recorded interactions to provide responses to requests made by the application when the client system is not connected to the server system.

In a third aspect of the invention, the present invention is a computer program product for having instructions stored on a computer readable medium which direct a computer to carry out program steps comprising: monitoring requests made by a client computer system to a server computer system, storing data relating to the requests from the client system and corresponding responses made by the server system, and providing responses to later requests made by the client system when a connection to the server system is not available.

### BRIEF DESCRIPTION OF THE DRAWINGS

Other aspects, features, and advantages of the present invention will become more fully apparent from the following detailed description, the appended claims, and the accompanying drawings in which:

FIG. 1 schematically shows components of a simple client/server system;

FIG. 2 schematically shows components of a simple client terminal;

FIGS. 3A, 3B, 3C schematically show three possible modes of operation for the system;

FIG. 4 depicts processes which may take place through a switch at the client in each of the three modes, in accordance with a preferred embodiment of the present invention;

FIG. 5 depicts a process which may take place at the switch in record mode at the client in accordance with a preferred embodiment of the present invention;

FIG. 6 depicts a process which may take place at the switch in remote mode at the client, in accordance with a preferred embodiment of the present invention;

FIG. 7 depicts data items which might be stored in the client during record mode, by way of example, in accordance with a preferred embodiment of the present invention;

FIG. 8 depicts a class structure for an implementation of the system using object oriented techniques, in accordance with a preferred embodiment of the present invention; and,

FIG. 9 depicts an outline of processes which may take place at the client during the three modes in accord with the class structure, in accordance with a preferred embodiment of the present invention.

### DETAILED DESCRIPTION OF THE PREFERRED EMBODIMENTS

Referring to the drawings it will be appreciated that the invention can be implemented in many forms with the following description being given by way of example only. The invention will be applicable in a wide range of client/server systems with a wide range of protocols for communication between clients and servers. Operation of these systems and the protocols will be understood by a skilled reader and details need not be given.

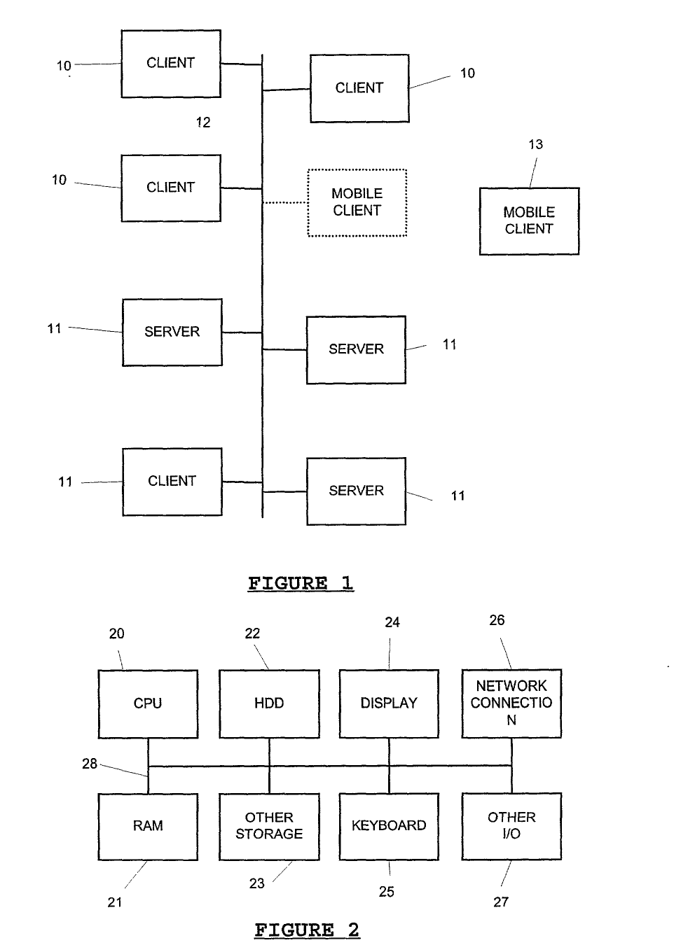

FIG. 1 indicates a simple client/server system with various clients 10 and servers 11 connected by a network 12. The client and server machines can take many forms and provide many functions in the network, and the network itself may include sub-networks and wired or wireless connections of various kinds. At least one client machine 13 can be disconnected from the network and operate as an independent unit. While linked by the network the machines may communicate with each other in various ways, using various protocols, including those defined under traditional RPC specifications, CORBA, DCOM and other middleware systems, as generally mentioned above. Other recent specifications such as XML are also becoming important in relation to the Internet. In general terms, an application or other program running client machine may request action at a particular server, such as access to a database, by transmitting a message over the network to the server and awaiting a response. The request will typically state a function which is defined on the server and provide data which is required to carry out the function. Functions are typically procedure calls each with one or more input parameters. The response is typically a single or multiple part item of data generated or retrieved by a process on the server. Together the request and response may be termed a transaction within the system.

FIG. 2 schematically shows the main components of a typical client machine 13 in FIG. 1, including a main processor represented by CPU 20, memory represented by RAM 21, a hard disc drive 22 and other storage such as a floppy disc drive 23, generally connected by bus system 28. The machine is able to implement various interfaces to a user by way of a display 24, keyboard 25, and other items such as a mouse pointer which have not been shown. A port 26 for wired or wireless connection of the machine to a network is also shown, along with other input/output possibilities 27. Applications and other programs which operate on the machine are normally stored as instructions on HDD 22 or FDD 23, and are accessed as required by the CPU 20 in conjunction with RAM 21. Instructions are stored as digital code on these devices as is well known. There are an enormous variety of hardware components and structures, and software applications or other programs, such as the operating system, which might be present in a machine of this general kind.

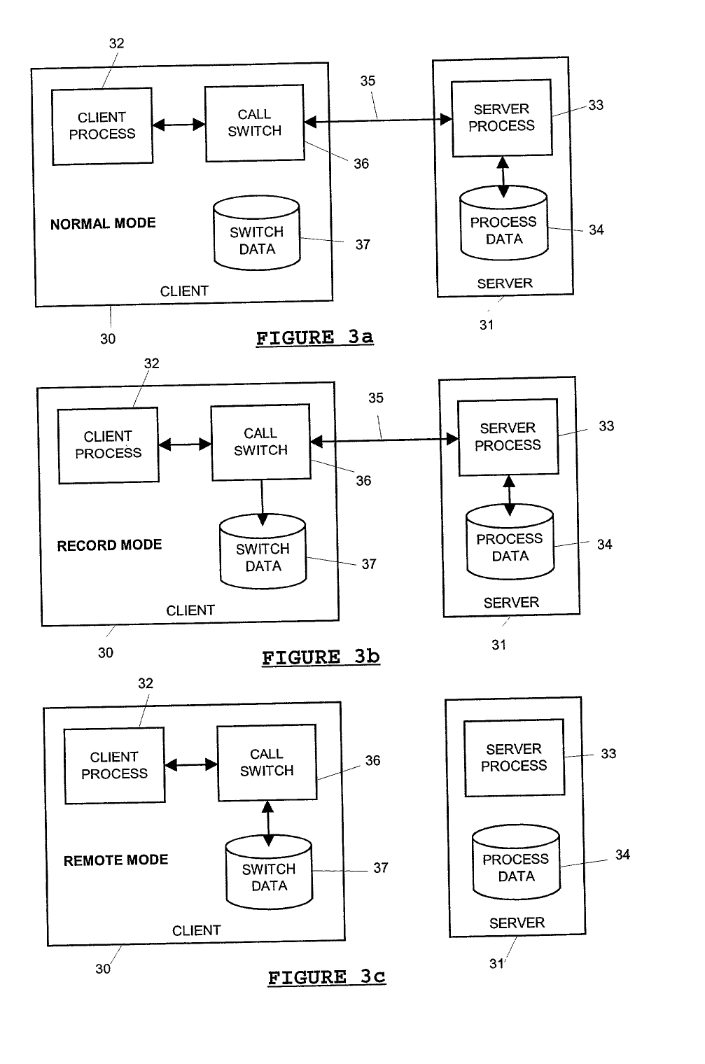

FIGS. 3A, 3B and 3C indicate how the invention may be implemented in a client/server system such as that shown in FIG. 1. A client 30 has three main modes of operation in relation to a server 31, stated as “Normal”, “Record” and “Remote” respectively. The client includes a program of any kind, indicated here as a process 32, typically an application which a user wishes to operate with and without connection to the network and the server 31. The server also includes a program or process 33 which is related to or otherwise provides access to a database 34. In this example the client process 32 requires data from the database in order to operate, and sends requests or calls for data by way of messages over the network as outlined above. The requests are issued by the client and transmitted through the network to the server using various possible routes and protocols indicated generally by link 35. Each relevant request is handled by the server process 33 which generates a response, perhaps by retrieval from the database 34. The response is then transmitted by the serverthrough the network to the client as also indicated by link 35. Single processes have been shown here for clarity, although any number of client processes and server processes could be involved in practice.

The client machine in FIGS. 3A, 3B, 3C also includes a program here termed a call switch 36 which monitors or tracks each request which is issued by process 32, and each corresponding response which is received from process 33. The switch program may store data relating to the requests and responses in a database 37 when required. In FIG. 3A a user operates the client machine in a “normal” mode, connected to the network, with process 32 operating in the usual way, and with full access to data 34 on the server, or other servers, as required. The switch 36 generally has little or no role in this mode and no information about operation of the client is stored in database 37. In FIG. 3B the user operates the client in a “record” mode, connected to the network as in FIG. 3A, except the switch now tracks some or all requests made by client process 32, and some or all corresponding responses made by server process 33. Information relating to the requests and responses is determined and stored by the switch in database 37. In FIG. 3C the user operates the client in a “remote” mode disconnected or otherwise out of immediate contact with the server. The user may be a sales agent demonstrating an application to a customer, for example. Requests made by the process 32 are now tracked by the switch and answered by generating responses from the information stored in database 37.

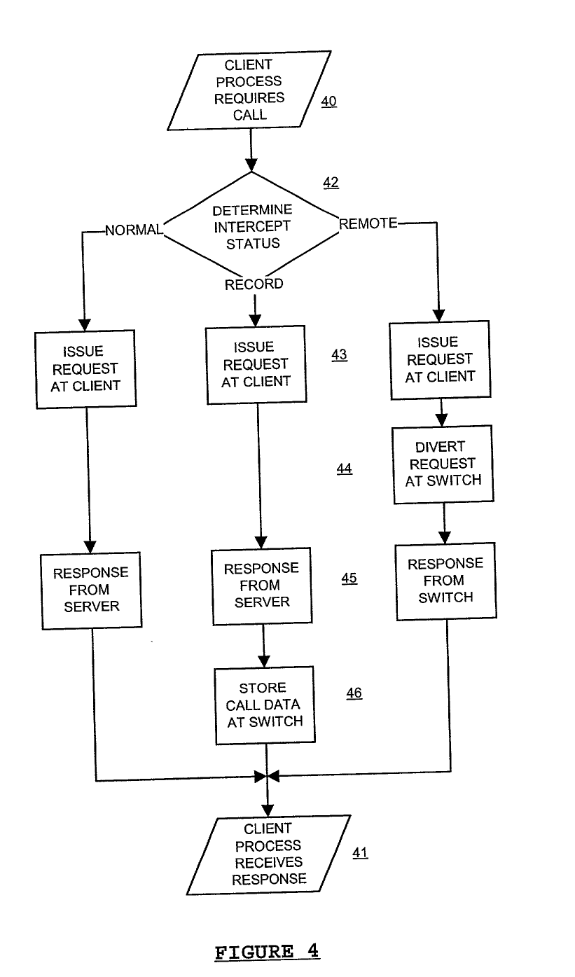

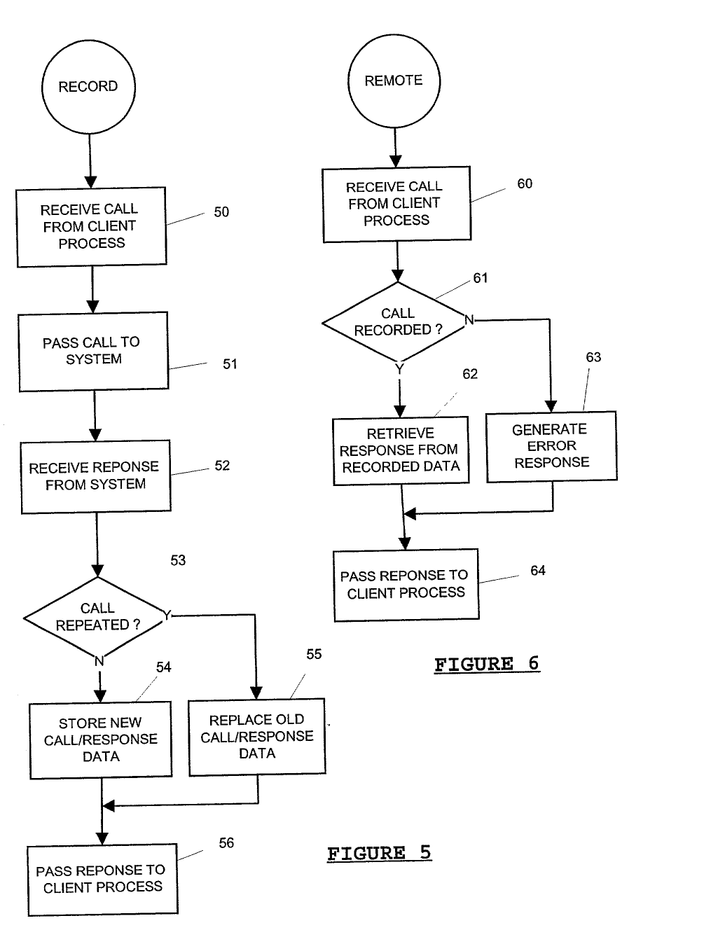

FIG. 4 outline the three modes in general terms for comparison. Overall the client process makes a request or call 40 for a result from a procedure on another machine, and receives a response 41 via the switch 36. The response is produced fresh from the other machine or generated locally by an action at the switch. The request is normally issued in accord with the status 42 of the switch which may or may not intercept and store data depending on the operational mode of the client. In normal mode the request is issued in step 43 and a response is made by the server in step 45. In record mode the request is issued in step 43 and response made in step 45, except data relating to both steps is keyed for later access and stored by the switch in step 46. Alternatives are possible within this mode, so that data relating to the request alone could be recorded prior to step 42, and data relating to the subsequent response alone could be recorded in step 46. In remote mode the request is issued in step 43 and intercepted by the switch in step 44 because the server itself is unable or not required to respond. The request is analyzed in the switch by comparison with earlier recorded transactions and a response is generated within the client. If there is no suitable earlier recorded transaction then an appropriate message is returned for the user.

FIG. 5 sets out steps of the record mode in more detail, as perceived at the switch 36. In step 50 a request, specifically stated here as a “call”, is received from a client process, usually a particular program which is arranged to cooperate with the switch. The call is passed to an appropriate recipient such as a server in the network system in step 51. A response is received by the switch in step 52. The nature of the calls may be analyzed in step 53, so that new calls are recorded as fresh items in step 54 for example, while repeated calls which have now received different responses overwrite previous data in step 55. In either case, the response is passed in step 56 on to continue normal operation of the client process.

FIG. 6 sets out steps of the remote mode as perceived at the switch 36. In step 60 a call is received from a client process. In step 61 the call is first analyzed to check whether a previous call of that kind has been recorded, such as a procedure call having the same name and parameters, for example. If so, then the corresponding response is retrieved from the database 37 in step 62. If not, then an error response is generated in step 63 to produce an appropriate message for the user. In each case, the response is passed on in step 64 to continue normal operation of the client process.

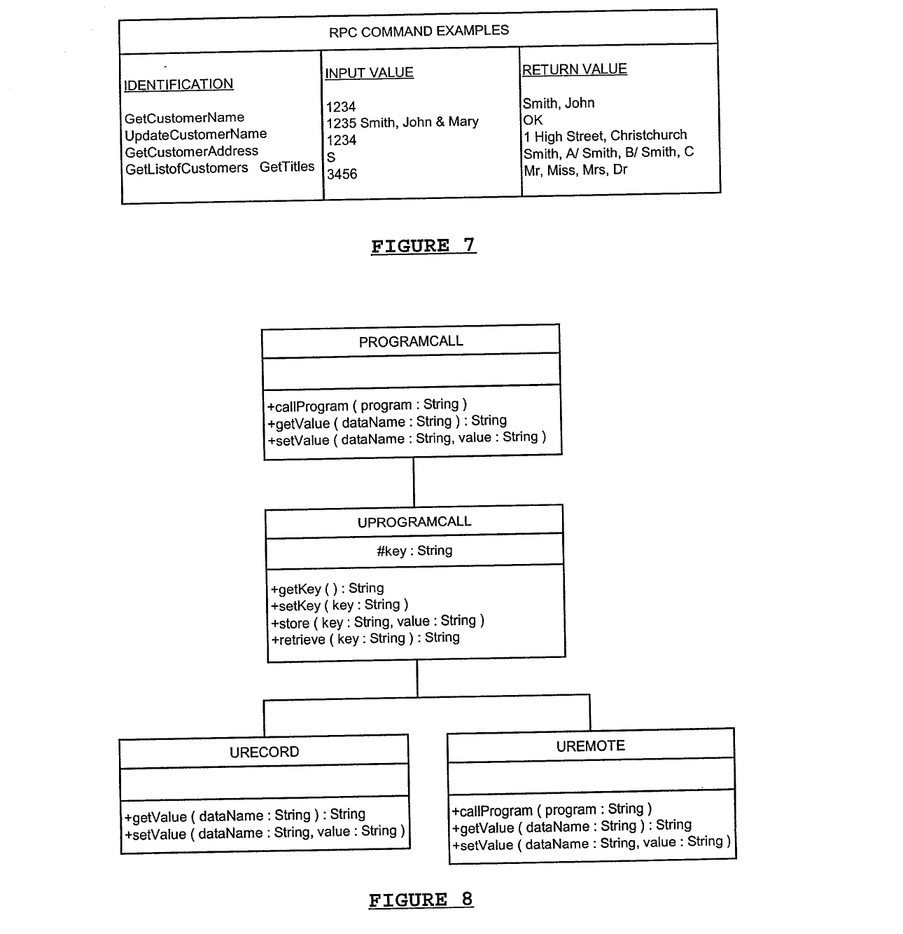

FIG. 7 provides a few examples of requests and responses that might be issued and received by a client process in FIG. 4. The requests are common procedure calls with parameters that might be used by an agent demonstrating software which maintains and processes customer-related information in some way. In the first example, a request is made for the name of customer number “1234”. The server action is to retrieve information for that customer number, and the response indicates a name John Smith in some format. The second example is a request to update the name to include a spouse, so that the full item relates to “John and Mary Smith”. The response from the server process is simply an acknowledgment “OK” that the change has been made. The remaining examples are self explanatory. In record mode the switch 36 stores these requests and responses, and keys them for access according to the procedure identification (ID) such as “GetCustomerName” and the parameters, such as customer number “1234”. In remote mode the switch compares the name and parameters of a further requests with those of the recorded requests to derive a response.

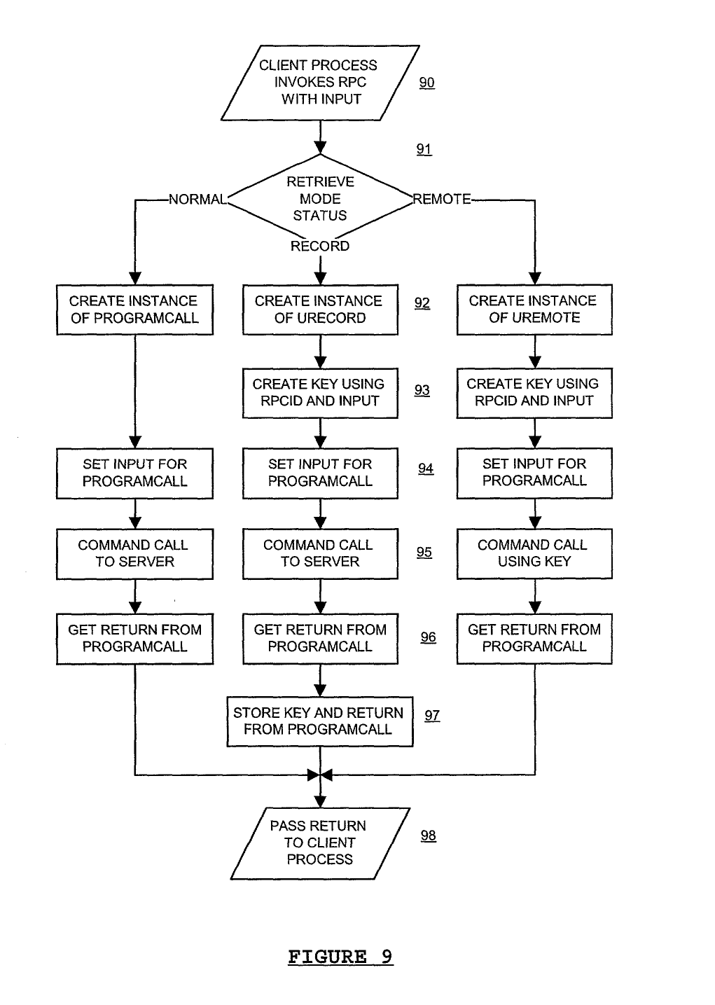

FIGS. 8 and 9 indicate a specific implementation of the invention using object oriented programming techniques. FIG. 8 is a class diagram indicating the main objects in the implementation. The class “Programcall” is a standard class which provides the object which actions a call from the client to the server. The methods “callProgram”, “setValue” and “getvalue” are respectively responsible for the call to the server, setting a value to be used by the application programming interface (API) to the server process 33, and returning a value from the API. This class is extended by the “Uprogramcall” class to enable additional methods required by the invention in this example. The methods “setkey” and “getkey” create and retrieve a unique key that is created for each instance of a request and response issued and received by the client from the server. The methods Astore≅ and Aretrieve≅ create and retrieve persistent values for the data which is stored in relation to each request and response. The class is further extended in specialist types “Urecord” and “U remote” which handle action of the switch in the record and remote modes.

FIG. 9 is a more detailed version of FIG. 4 which outlines the flow of actions in the implementation of FIG. 8. Given a call 90 invoked by the client process, the switch 36 determines the current mode; normal, record or remote in step 91, and creates an instance of the Programcall, Urecord or Uremote classes respectively in step 92. For the record and remote modes the switch in step 93 then creates a unique key using the call ID and input values. An input value is set on the Programcall class in step 94, and in step 95, the class is commanded to call the server in the normal and record modes, or retrieve data from the database 37 in the remote mode using the key from step 93. The switch then gets a return value from the Programcall class in step 96. The response must be stored in the record mode in step 97, according to the key from step 93. The return value 98 is then provided to the client process as a response to the call 90.

What is claimed is:

1. A method of operating a client in a client/server system comprising:
issuing a plurality of requests for action to one or more servers in the system,
receiving a plurality of corresponding responses to the requests from the system,
recording data at the client relating to the requests and the responses,
disconnecting the client from communication with the system,
issuing one or more further requests for action, and
determining responses to the further requests according to the recorded data.

2. The method according to claim 1 wherein:
the data recorded at the client is keyed for access according to a reference to a procedure and input required by the procedure.

3. The method according to claim 1 wherein:
the requests for action include one or more procedure calls and the data recorded at the client includes one ore more references to the procedure calls.

4. The method according to claim 3 wherein:
the further requests for action include procedure calls and responses to the further requests are determined by comparison of the calls with references to previous calls recorded at the client.

5. The method according to claim 1 wherein:
at least one or more of the requests include a call for a procedure and one or more input values required by the procedure, and
the data recorded at the client includes the name of the procedure, the input values, and the respective response.

6. A client computer system including:
a connector subsystem which enables connection of the client computer system to a server computer system,
at least one client application which can be operated by a user of the client computer system, and
a switch subsystem for tracking requests made by the client application to the server system,
wherein the switch records request and response interactions between the application and the server system while the client system is connected to the server system, and
the switch uses the recorded interactions to provide responses to requests made by the application when the client system is not connected to the server system.

7. The client computer system according to claim 6 wherein:
the request and response interactions include procedure calls by the client application and data returns from a server application.

8. The client computer system according to claim 6 wherein:
the switch subsystem records data including references to procedure calls, input values required by the procedure calls, and output values returned from the procedure calls.

9. The client computer system according to claim 6 wherein:
the client application is a computer program which demonstrates performance of the client and server systems during remote operation of the client system.

10. A computer program product having instructions stored on a computer readable medium which direct a computer to carry out program steps comprising:
monitoring requests made by a client computer system to a server computer system,
storing data relating to the requests from the client system and corresponding responses made by the server system, and
providing responses to later requests made by the client system when a connection to the server system is not available.

11. The product according to claim 10 wherein:
the data which is stored in relation to requests made by the server includes references to procedure calls and any values required by the procedure calls.

12. The product according to claim 10 wherein:
the responses to requests made when the server system is not available are determined by comparing information contained by each request with stored data including information contained by previous requests when the server system is available.

13. The product according to claim 10 wherein:
the responses to requests made when the server system is not available include stored data from responses to substantially identical requests made when the server system was available.
